(19) United States
(12) Patent Application Publication
(10) Pub. No.: US 2005/0057215 A1
(43) Pub. Date: Mar. 17, 2005

(54) Systems and methods for charging a battery

(76) Inventor: Stefan Matan, Novato, CA (US)

Correspondence Address: TRAN & ASSOCIATES, 6768 MEADOW VISTA CT., SAN JOSE, CA, 95135, US

(21) Appl. No.: 10/662,861

(22) Filed: Sep. 15, 2003

(51) Int. Cl. H02J 7/32

(52) U.S. Cl. 320/101

(57) ABSTRACT

A charger includes an alternating current (AC) voltage booster coupled to an input voltage; and a DC regulator coupled to the AC voltage booster to charge a battery. An energy supply system includes a solar panel to generate an input voltage from solar energy; a battery; an alternating current (AC) voltage booster coupled to the solar panel to receive the input voltage; and a DC regulator coupled to the AC voltage booster to charge the battery.

### BACKGROUND

This invention relates to systems and methods for generating rechargeable energy.

In recent years all types of electrical equipment have been miniaturized and made lightweight, and many portable electronic products have become available. Since commercial alternating current cannot be used with portable electrical equipment, batteries are used. Single use batteries such as dry-cell batteries and rechargeable batteries such as nickel-cadmium batteries are well known battery power sources. However, since rechargeable batteries can be repeatedly re-used simply by charging and have large capacity allowing high current discharge, they are extremely convenient to use.

It is known that rechargeable batteries can be charged using commercial alternating current or using solar cells. Commercial alternating current (AC) has the drawback that it is typically used only indoors and cannot be used outdoors to immediately recharge electrical equipment with low batteries. For this reason, it is necessary to carry a spare battery. A further drawback of charging with commercial alternating current is that rectifying circuitry is required to convert the alternating current to direct current, resulting in complex charging circuitry. Further, the use of petroleum in AC production involves generation of carbon dioxide which causes global warming, so that solar cells have drawn attention as an alternative energy source.

Typically, solar cells employ a semiconductor pn junction as a photoelectric conversion layer for converting optical energy into electric power and silicon is mainly utilized as a semiconductor material comprising the pn junction. Crystalline silicon solar cells utilizing materials including monocrystalline silicon and the like are advantageous in photovoltaic conversion efficiency and have already been put into practical use.

As mentioned in U.S. Pat. No. 5,855,692, rechargeable batteries can be charged by solar cells indoors or outdoors as long as the solar cells produce electricity. Therefore, batteries can be recharged even when they run-down while portable equipment is being carried about. Since solar cells do not use commercial alternating current, they are economical. Further, since solar cell output is direct current, no alternating current conversion circuitry is required.

Since all of the light energy cannot be converted to electrical energy, sufficient output cannot easily be obtained. For this reason, the light receiving area of solar cells must be made large in order to obtain enough output to charge batteries. Further, advances in rechargeable battery technology have lead to the availability of high capacity nickel-hydrogen batteries and lithium ion batteries with higher voltage per cell than nickel-cadmium batteries. Consequently, charging current and voltage are increased for charging these various types of batteries and the light receiving area of the solar cells must be further increased. For this reason, solar cells are increased such that it is difficult to make a battery charger powered by solar cells which is portable.

Conventionally, when the power source is a solar panel the minimum input voltage to charge a battery is 3 to 4 volts higher than the static battery capacity at that point. However, when the intensity of the sun is not above a certain charging point, charging will not occur. When the intensity of the sun is low, i.e. below a minimum charging level, conventional chargers stop working. As a result, batteries are not recharged during periods of low sunlight intensity.

On a related note, the footprint of large solar cells can be made smaller when not in use if the solar cells are designed to be folded up. Japanese Non-examined Utility Model Publication No. SHO61 123550, issued 1986, discloses a solar cell apparatus comprising a plurality of solar cell devices connected by leads which can bend. This configuration of solar cell apparatus has the characteristic that it can be folded up and made compact when not in use. Further, solar cells can be mounted on folding parts of electrical equipment such as portable telephones which have a case structure allowing parts to bend and fold up. Apparatus with solar cells mounted on folding parts of the case have solar cells on more than one surface of the case and have the characteristic that solar cell area and hence power output can be made larger.

### SUMMARY

Advantages of the invention may include one or more of the following. The system provides a charger that recharges batteries even in low levels of sunlight. The battery charger with battery and solar cells is portable and light weight. The system can be quickly set to recharge run-down batteries to power portable electrical equipment used outdoors. The system also provides a housing enclosure which can carry portable electrical equipment housing rechargeable batteries without degrading those rechargeable batteries. When not in use, solar cells are folded into a cube-shape. During operation, the solar cells can charge the rechargeable batteries when the solar cells are extended. Additionally, the solar cells can charge an external source such as a car, a recreational vehicle, a boat. Another advantage is that the excess energy produced by solar cell can be sent back to grid or other external source to charge batteries.

### BRIEF DESCRIPTION OF THE DRAWINGS

The above and further objects and features of the invention will more fully be apparent from the following detailed description with accompanying drawings.

FIG. 1 shows an exemplary embodiment of a power supply system.

FIG. 2 shows an exemplary charger circuit.

FIG. 3 illustrates in more detail an implementation of an oscillator.

FIG. 4 shows an exemplary inverter circuit.

FIG. 5 illustrates an implementation of a regulator circuit.

FIG. 6 shows another exemplary charger circuit.

FIG. 7 illustrates in more detail the operation of the charger circuit of FIG. 6.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### DESCRIPTION

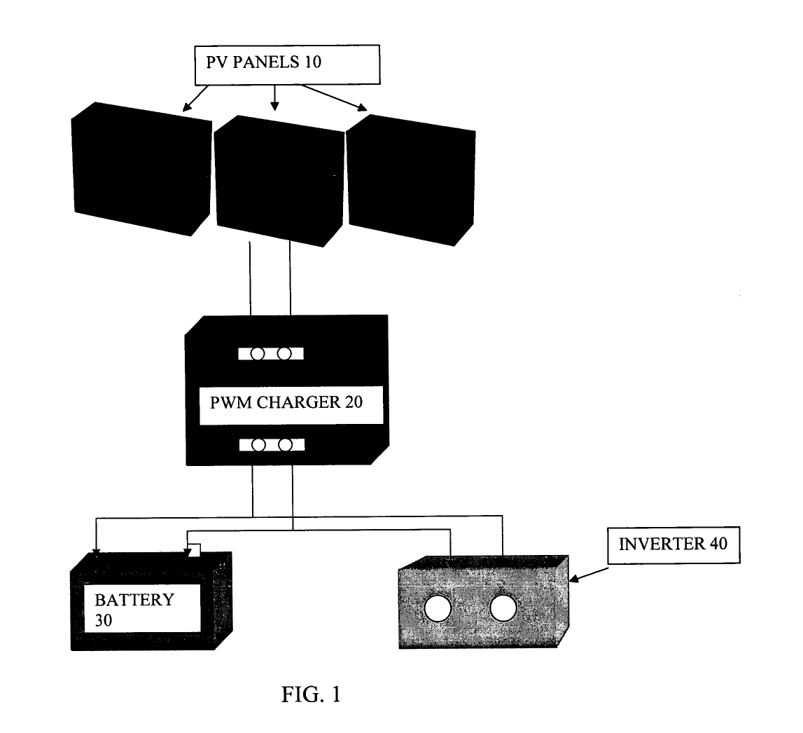

FIG. 1 shows an exemplary embodiment of a power supply system. In this embodiment, a power source 10 provides power to a charger 20 that uses a pulse-width-modulation (PWM) controller and a direct current (DC) Load Control and Battery Protection circuit. The output of the charger 20 is provided to one or more battery units 30. The output of the battery units 30 in turn is provided to an inverter 40 for generating AC voltages to operate conventional equipment.

The power source 10 can be one or more solar cells that produce a supply voltage Vin. The number of solar cells connected together in this embodiment may also be increased making it easy to change the solar cell output. The solar cells can be connected in parallel to increase the supply current, or can be connected in series to increase the supply voltage. During use, the solar cells can be spread open to increase their light receiving area for use in charging a battery pack, and can also be folded into a compact form to be stowed when not in use. Since the solar cells are thin, the solar cell cube is relatively compact. The solar cells may be made larger by increasing the number of amorphous silicon solar cell units. A plurality of solar cells may also be connected electrically by cables or other connectors. In this fashion, solar cell output can easily be changed. Hence, even if the voltage or capacity requirements of batteries change, the charging output can easily be revised to adapt to the new requirements.

In one embodiment, the controller in the charger 20 boosts the voltage received from the power source 10. Input voltage boosting is required so that the battery can be charged. To illustrate, if the power source 10 generates only 1.5V of electricity, it is not possible to charge a 12V battery using 1.5V power source. The charger 20 converts and boosts the voltage to more than 12V so that the charging of a 12V battery can begin.

In one embodiment, the boosting of the voltage level is achieved using a transformer. DC electricity does not have the frequency to create magnetic pole through the transformer (transformer can work only with magnetic pole). The DC electricity is applied to a transistor circuit configured as an oscillator at the first side of the transformer coil. The DC electricity is thus converted into an AC electricity form. Once the secondary coil receives the magnetic pole and boosts the AC electricity to the appropriate voltage level, the AC voltage is converted back to DC electricity using a diode and stabilized by a capacitor. The voltage step-up by the transformer requires a relatively significant amount of energy to operate the charger 20. Hence, in another embodiment, a pulse-width-modulator (PWM) is used to boost the voltage.

Once the DC electrical impulse has been formed, the impulse is passed to a DC load control and battery protection circuit in the charger 20. The circuit is tailored for each battery technology in the battery unit 30, including nickel cadmium (Ni—CD) batteries, lithium ion batteries, lead acid batteries, among others. For example Ni—CD batteries need to be discharged before charging occurs.

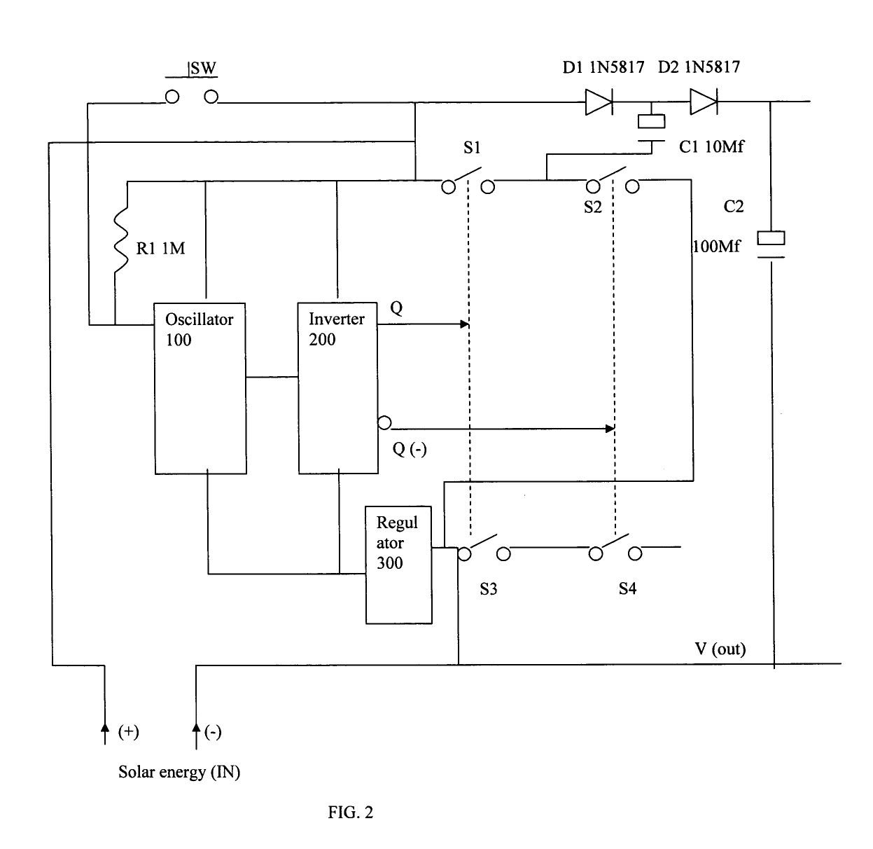

FIG. 2 illustrates one embodiment of the charger 20. In this embodiment, a PWM controller is used for charging batteries. As shown in FIG. 2, oscillator 100 drives inverter 200 and regulator 300. Voltage from power supply 10 such as solar energy is provided to oscillator 100 and inverter 200 at pin 8. Resistor R1 is connected between pin 8 and pin 1, and pin 1 is also connected to one input of switch SW. The other input of switch SW is connected to diode D1. Diode D1 also drives diode D2, which provides an output voltage to charge the battery unit 30. Diode D2 in turn is connected to capacitor C2 to store and smooth the output voltage.

The other input of diode D1 is connected to a capacitor C1 which is connected to pin 2. Switch S1 is positioned between input power and capacitor C1. One input of switch S2 is also connected to the node between switch S1 and capacitor C1, while the other input is connected to the output of regulator 300. The output of regulator 300 is provided to one terminal of switch S3 and to pin 4. The other terminal of switch S3 is connected to switch S4, which is connected to pin 5.

In one embodiment, each of switches S1-S4 is a MOSFET switch. During the first half of each cycle, switches S1 and S3 close and S2 and S4 open, which connect capacitor C1 and charge capacitor C1. During the second half of the cycle S1 and S3 open and S2 and S4 close and connect the negative side of the capacitor to the output voltage. This operation connects C1 in parallel with C2, so if the charge on C2 is smaller than C1 the charge will flow to equalize both capacitors. During the second cycle C1 will charge again above C2 and will discharge until the charge is equalized. The energy from C2 is discharged during the charging of the battery unit 30.

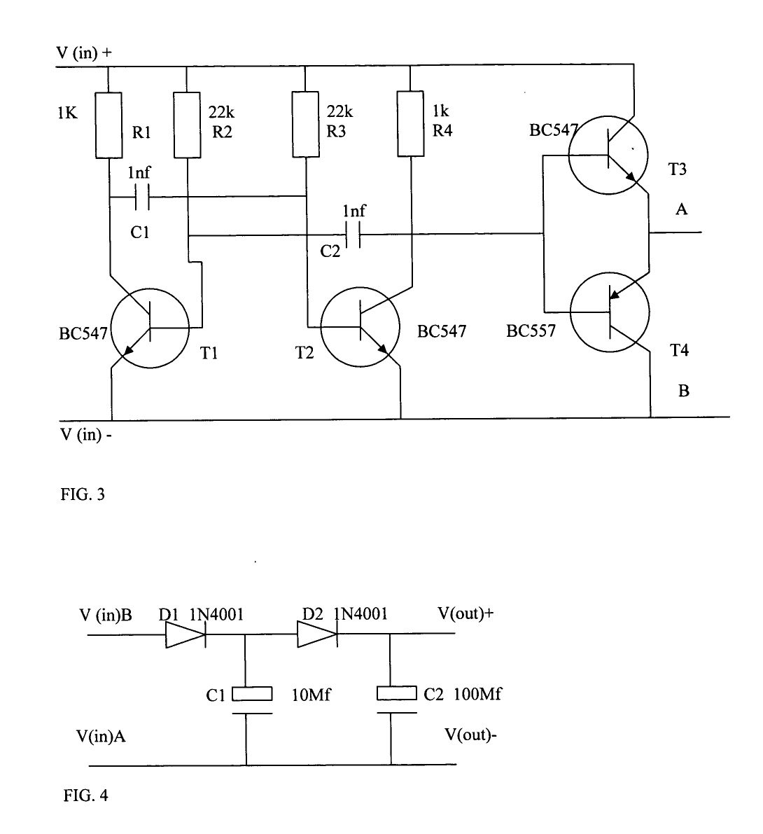

FIG. 3 illustrates in more detail an implementation of oscillator 100. Resistors R1-R4 are connected to the input voltage. Resistor R1 is also connected to the collector terminal of transistor T1, while resistor R2 is connected to the base of transistor T1. The emitter of transistor T1 is connected to ground. Resistor R3 is connected to the base of transistor T2, while resistor R4 is connected to the collector of transistor T2 and the emitter of transistor T2 is connected to the ground. Capacitor C2 connects the base of transistor T1 to the bases of transistors T3 and T4, while the emitter terminals of transistors T3 and T4 are connected together.

The circuit of FIG. 3 is a multi-vibrator which creates a 50 KHz square wave in one embodiment. It is free running and does not require set voltage—it could be from 3V to 18V. The oscillator of FIG. 3 provides the pulse-width modulation. Now the high frequency signal needs to be modified by the inverter 200.

FIG. 4 shows an exemplary inverter 200. In FIG. 4, input voltage is provided to diode D1, which drives capacitor C1 and diode D2. The output of diode D2 is smoothed by capacitor C2. Once the high frequency enters through D1, AC current is transferred to a single DC pulse (already doubled in voltage) and stored at capacitor C1. When the energy is discharged from the capacitor C1, energy is transferred through D2 and charges capacitor C2. The energy cannot be reversed because of the diodes, so the only way is to move forward to the point to be consumed. Each diode/capacitor pair stage doubles the input voltage.

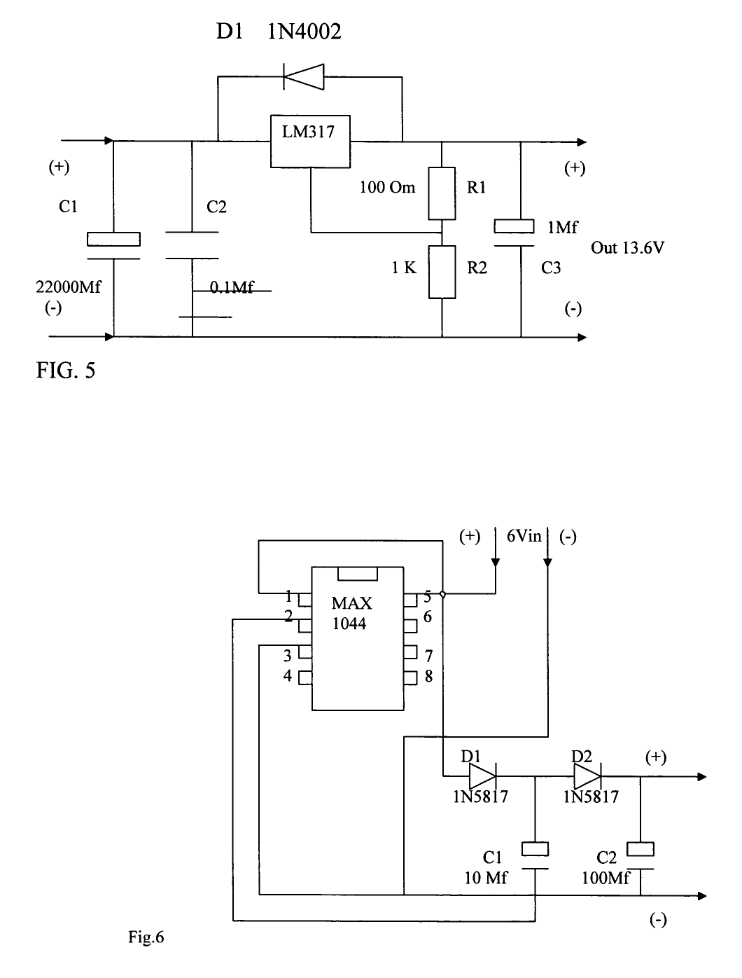

FIG. 5 illustrates an implementation of regulator 300. Once the energy is transferred to a certain point, a regulator is used give us the desired charging voltage. The capacitor C1 act as an energy storage device as well as a voltage stabilizer. LM317 is a voltage regulator for 13.6 V to provide sufficient voltage for charging a 12V battery embodiment. R1 and R2 act as a buffer to insure smooth current flow to the battery. Any small peak will be capped and later discharge from C3.

FIG. 6 shows another exemplary charger circuit. In this embodiment, a controller is a charge pump converter which uses a capacitor as a “storage tank” to pump charge from one place to another. A Maxim MAX1044 device is used. Normally, there is a capacitor connected from pin 2 of the MAX1044 to pin 4. This capacitor is charged between +9V and ground, and then switched in parallel with a capacitor from pin 5 to ground in a way that makes a negative voltage on the second capacitor. In this inverting use, the MAX1044 still switches pin 2 between +9V and ground just as it would for a voltage inverter. However, pin 4 and 5 connections that would make an inverter from the MAX1044 are not used. Instead, capacitors C1-C2 and diodes D1-D2 are used. The voltage on pin 2 of the MAX1044 is switched from +9V to ground. When the voltage on pin 2 is switched to ground, C1 fills with voltage through D1. When the voltage on pin 2 is then switched to +9V, it pulls the negative terminal of C1 up to +9V. D1 now blocks any flow of current back into the battery, so the charge in C1 flows through D2 into C2. So, at C2, nearly 18V is obtained. The limit on this charge pumping operation is the losses in the diode voltages. Each time a section is added, two more diode voltage drops occur.

In the embodiment of FIG. 6, the capacitors can have the same value, but C1, C2 need to be 25V units, C3, 4, 5, and 6 can be 35V units, and C5 and C6 might need to be a 50V unit for safety margin. 1N400x diodes can be used and they are inexpensive, but the losses are higher than they really need to be. For higher performance and lower losses, a 1N5817 Schottky diodes is used for low losses. The MAX1044 runs at about 7-10 kHz, so there will be a ripple of that amount on the C2 output and on the +9V output from the battery as well. Audio equipment that uses this voltage could have a “whine” audible. To avoid interference with audio equipment, the MAX1044's frequency boost feature is used to increase the oscillation frequency well above audio equipment operating frequency. Thus, in one embodiment, pin 1 of the MAX1044 is connected to the power supply through a switch to increase the oscillator frequency by about 6:1. The oscillator then works well above the audio region. Any whine is then going to be inaudible.

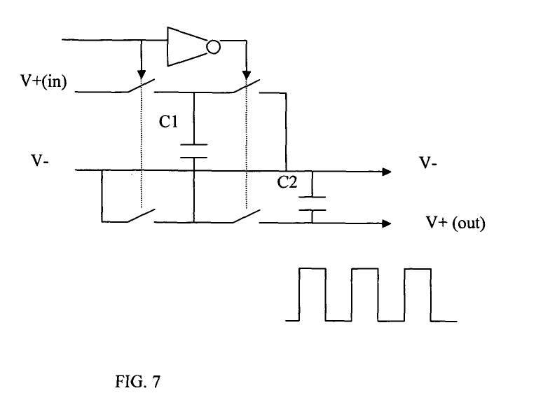

FIG. 7 shows an example of the AC voltage boosting performed using the circuit of FIG. 6. The voltage on pin 2 of the 1044 is switched from +V to ground. When it switches to ground, C1 fills with voltage through D1. When it then switches to (−), it pulls the negative terminal of C1 up to +V. D1 now blocks any flow of current back into the V source, so the charge in C1 flows through D2 into C2. So at C2, a proximally double voltage is generated. The PWM voltage booster of FIG. 7 has a pulse that is about 45 Khz. As the source input voltage drops, the PWM signal is lengthened to allow more time for charging the capacitors.

It will be apparent to those skilled in the art that various modifications and variation can be made in the present invention without departing from the spirit or scope of the invention. Thus, it is intended that the present invention covers the modifications and variations of this invention provided they come within the scope of the appended claims and their equivalents.

1. A charger, comprising:
an alternating current (AC) voltage booster coupled to an input voltage; and
a DC regulator coupled to the AC voltage booster to charge a battery.

2. The charger of claim 1, wherein the AC voltage booster is a pulse-width-modulation (PWM) voltage booster.

3. The charger of claim 1, wherein the input voltage is generated by a renewable energy source.

4. The charger of claim 1, wherein the input voltage comes from a solar cell.

5. The charger of claim 1, wherein the voltage booster doubles the input voltage.

6. The charger of claim 1, further comprising in one or more capacitors for storing the stepped-up voltage before applying the stepped-up voltage to the battery.

7. The charger of claim 1, further comprising a circuit to convert the stepped-up voltage to a stepped-up DC voltage.

8. The charger of claim 1, further comprising a frequency shifter to change a frequency of the AC voltage to avoid radio frequency interference.

9. The charger of claim 1, wherein the voltage booster is a charge pump.

10. The charger of claim 1, further comprising a DC regulator coupled between the voltage booster and the battery.

11. A method for charging a battery, comprising:
receiving a direct current (DC) input voltage;
converting the direct current input voltage into an alternating current (AC) voltage;
stepping-up the AC input voltage; and
applying the stepped-up voltage to the battery.

12. The method of claim 11, further comprising stepping-up the input voltage using pulse-width-modulation (PWM).

13. The method of claim 11, wherein the input voltage is generated by a renewable energy source.

14. The method of claim 11, wherein the input voltage comes from a solar cell.

15. The method of claim 11, wherein the stepping up the input voltage further comprises proximally doubling the input voltage.

16. The method of claim 11, further comprising storing the stepped-up voltage in one or more capacitors before applying the stepped-up voltage to the battery.

17. The method of claim 11, wherein the applying the stepped-up voltage further comprises converting the stepped-up voltage to a stepped-up DC voltage.

18. The method of claim 11, further comprising changing a frequency of the AC voltage to avoid radio frequency interference.

19. A system for charging a battery, comprising:
means for converting a direct current (DC) input voltage into an alternating current (AC) voltage;
means for stepping-up the input voltage and applying the stepped-up voltage to the battery.

20. The system of claim 19, further comprising means to convert the stepped-up voltage to a stepped up DC voltage.
